(19) United States
(12) Patent Application Publication
(10) Pub. No.: US 2026/0066786 A1
(43) Pub. Date: Mar. 5, 2026

(54) INTEGRATED VOLTAGE REGULATOR

(71) Applicant: Intel Corporation, Santa Clara, CA (US)

(72) Inventors: Keng CHEN, Acton, MA (US); Huanhuan ZHANG, Ashland, MA (US); Kishan JOSHI, Mountain House, CA (US); Avinash SHREEPATHI BHAT, Vancouver, WA (US); Arvind RAGHAVAN, Lexington, MA (US)

(21) Appl. No.: 18/819,087

(22) Filed: Aug. 29, 2024

(51) Int. Cl. H02M 3/158; H01L 25/065; H02M 1/00; H02M 3/157

(52) U.S. Cl. CPC H02M 3/158; H02M 3/157; H02M 1/0058

(57) ABSTRACT

In some embodiments, a voltage regulator with circuitry to facilitate DCM to CCM transitions are provided to mitigate against excessive voltage droops.

### TECHNICAL FIELD

Embodiments of the invention relate to the field of semiconductor circuits; and more specifically, to the field of voltage regulators.

### BRIEF DESCRIPTION OF THE DRAWINGS

The disclosure may best be understood by referring to the following description and accompanying drawings that are used to illustrate embodiments of the invention. In the drawings:

FIG. 1A is a schematic diagram of a buck type DC-DC converter with a conventional pulse width modulation control scheme.

FIG. 1B is a signal timing diagram illustrating operating aspects of the regulator of FIG. 1A.

FIG. 2A is a schematic diagram of a buck type regulator with a pulse width modulation circuit in accordance with some embodiments.

FIG. 2B is a flow diagram showing a routine for implementing a DCC select circuit in accordance with some embodiments.

FIG. 2C is a signal timing diagram illustrating operating aspects of the regulator of FIG. 2A in accordance with some embodiments.

FIG. 3 is a schematic diagram showing a regulator with duty cycle control circuitry in accordance with additional different embodiments.

FIG. 4 is a schematic diagram showing a regulator with duty cycle control circuitry in accordance with yet additional different embodiments.

FIG. 5 is a schematic diagram showing a regulator with duty cycle control circuitry in accordance with additional different embodiments.

FIG. 6 is a schematic diagram showing a regulator with duty cycle control circuitry in accordance with additional different embodiments.

FIG. 7 is a schematic diagram showing an integrated circuit (IC) package 700 in accordance with some embodiments.

FIG. 8 illustrates an example computing system with a voltage regulator in accordance with some embodiments.

### DETAILED DESCRIPTION

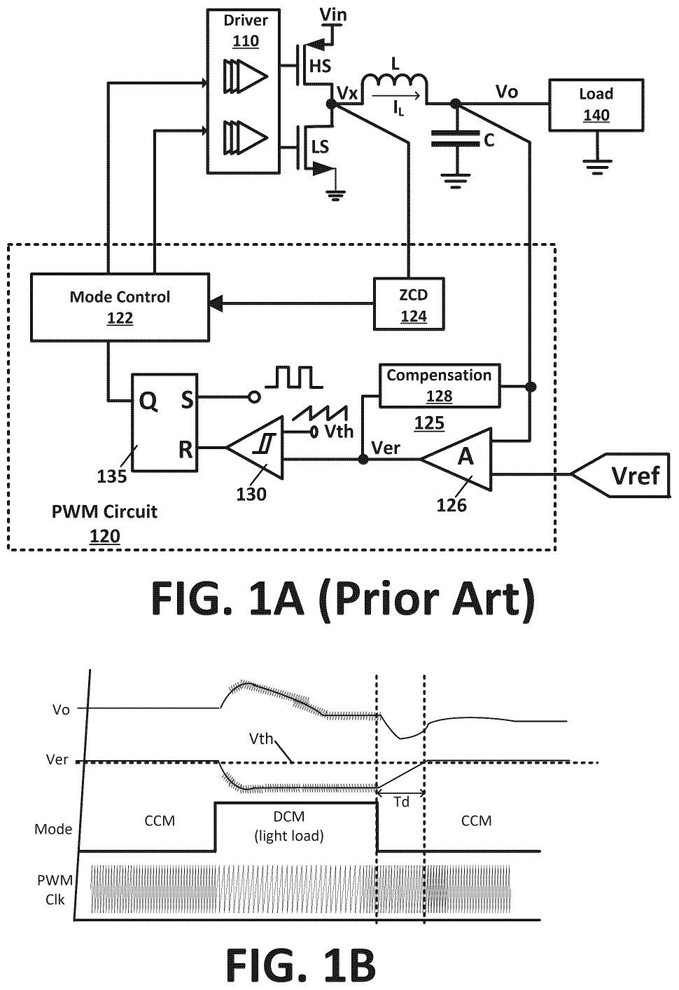

FIG. 1A is a schematic diagram of a conventional switching type DC-DC converter, also referred to as a switching DC-DC voltage regulator. There are different types of switching regulators including buck types for stepping down a DC voltage, boost types for stepping up a DC voltage, or buck-boost types for doing either or both stepping down and stepping up a DC voltage. With this disclosure, a buck type regulator is used to present the concepts disclosed herein but it should be appreciated that they may be employed with other types of switching DC-DC converters as well.

With reference to the figure, a buck converter may generally include power switches including a high side power switch (HS) and a low side power switch (LS), an inductor (L), a capacitor (C), a driver circuit 110, and a pulse width modulation (PWM) circuit 120, coupled together as shown to provide the output voltage supply (Vo) to a load 140.

The high and low side power switches are typically implemented with transistors such as P and/or N type metal oxide semiconductor field effect transistors (MOSFETs), although the low-side switch may be implemented with a diode in some designs. With this example, the high side switch (HS) is a P-type MOS transistor, and the low side switch (LS) is an N-type MOS transistor. (There are also some designs that group together transistors, in parallel, series, or both, to form the high and/or low side switches. Similarly, while it is easier to control switching for designs, as shown, with a high side P-type switch and a low-side N type switch, some designs may use N-type or P-type devices for either or both power switches.)

The power switches are controlled by the PWM circuit 120 through the driver circuit 110 to regulate the output voltage at a level that corresponds to Vref. The PWM (pulse width modulation) circuit generates the control signals that dictate the switching frequency and duty cycle of the power switches. It compares the output voltage (Vo) to the reference voltage (Vref) and adjusts the duty cycle accordingly to maintain the desired output voltage.

The inductor and capacitor form a low-pass filter to smooth the output voltage. Buck operation is based on the principle of storing energy in the inductor. When the HS switch is on, the inductor stores energy by allowing current (IL) to flow through it and on into the load and capacitor. Conversely, when the high switch is off, the inductor releases its stored energy to the load and output capacitor.

The driver circuit 110 is responsible for providing the necessary voltage and current to turn the power switches on and off quickly. Ideally, it facilitates efficient switching and minimizes transition losses. The driver circuit may be integrated into the PWM circuit 120 or implemented as separate components.

The PWM circuit 120 essentially controls the ratio of on-time to off-time (duty cycle) of the HS switch to regulate the output voltage to a desired value. It includes a mode control circuit 122, zero cross detector (ZCD) circuit 124, feedback amplifier 125, comparator 130, and latch 135, coupled as shown, to control drive circuit 110 to provide the high and low side switches with suitable pulse train signals to regulate the output voltage (Vo) to track the selected reference voltage (Vref).

The feedback amplifier 125 has amplifier 126 and feedback compensation circuit 128 (e.g., appropriate RC combination in amplifier feedback path) to provide an amplified error signal, difference between the sensed output voltage (Vo) and the desired regulated voltage level (Vref), with a suitable frequency response, providing a compensated error signal (Ver) to an input of the comparator 130. The other comparator input receives a triangle signal having a frequency corresponding to the PWM frequency. The Ver acts as a dynamic reference to the triangle signal, causing the comparator to assert for a longer duration of a cycle as the compensated feedback (Ver) is larger, with the output being greater than Vref. On the other hand, the comparator will assert for a smaller duration in each cycle, resulting in a larger PWM duty cycle, when the Ver signal is smaller.

The latch 135 has an output (Q) that is provided to the mode control circuit 122 to provide it with a pulse train having a controllable duty cycle. It has a “Set” input(S) coupled to a pulse signal generator (not shown) and a “reset” input coupled to the output of the comparator 130. When the comparator output asserts (resetting the latch), the PWM duty cycle decreases and conversely, when it de-asserts, the duty cycle increases. Thus, a negative feedback voltage control loop is facilitated with the duty cycle decreasing as the output voltage (Vo), and in turn error voltage (Ver), go up.

A function of the mode control circuit 122, based on a signal from the ZCD circuit 124, is to control the conduction mode of the regulator. Buck regulators are typically designed to work in different operational states including a continuous conduction mode (CCM) or a discontinuous conduction mode (DCM) based on the behavior of the inductor current during a switching cycle. The ZCD circuit 124 monitors this behavior, notifying the mode control circuit 122 when the inductor current is approaching, crossing, or has sufficiently crossed a zero-current level.

In general, the buck converter operates in CCM under heavy loads and switches to DCM as the load decreases. With most designs, CCM occurs when the monitored inductor current remains above zero, allowing for the inductor current to more continuously be conducted through to the load. When in this mode, the high and low switches are controlled such that the high switch is on (low switch off) when the PWM pulse asserts, the low side switch is on (high switch off) when the PWM signal de-asserts, and both switches are off for a “dead” time when the PWM pulse is transitioning to avoid a short through the switches. On the other hand, DCM is typically activated when the inductor current falls to zero (or sufficiently close to or beyond zero) during a switching cycle, as identified by the ZCD circuit 124. In such a discontinuous conduction mode, the low switch (LS) is turned off to prevent excessive negative current flowing back through the inductor. DCM is typically more efficient for lighter operational loads, but it also usually results in larger output voltage ripple.

With reference to FIG. 1B, it is a challenge for an integrated buck type regulator to transition from the Discontinuous conduction to continuous conduction mode. When the PWM circuit is in the discontinuous conduction mode, the compensated feedback error signal (Ver) can be subjected to a relatively large variation due to the large output voltage ripple, which is amplified by the feedback amplifier 126. As this feedback loop, with compensation amplifier 125, is typically based on either a “type-II” or “type-III” compensation network, the bandwidth of this feedback-sensing scheme will be limited. For light load operation when substantially in discontinuous mode, this is normally not a significant problem. However, when the load is abruptly increased (large di/dt slew rate), the feedback loop (Ver) can effectively stall at its DCM level, which may be relatively low. This is illustrated in FIG. 1B where it can be seen that the feedback error signal (Ver) is below a higher threshold (Vth) corresponding to higher duty cycles that would otherwise be applied for larger load conditions. The feedback loop's “catch-up” delay (illustrated as Td in the figure) results in a smaller PWM duty cycle. As is shown in the figure, this limits the regulator's undershoot performance, its ability to adequately respond to the voltage droop caused by the load increase.

Because of this, in some previous implementations, DCM operational mode is disabled with certain critical applications to better satisfy voltage droop responsiveness, as well as to meet ripple and noise specifications. Unfortunately, since DCM operation can boost efficiency (e.g., by 4% to 5% under light load conditions), disabling the DCM mode causes overall system efficiency to be reduced. Accordingly, it would be desirable to be able to retain DCM operation and at the same time, mitigate against slower voltage droop responsiveness that can occur when transitioning from DCM to CCM for increased load transitions.

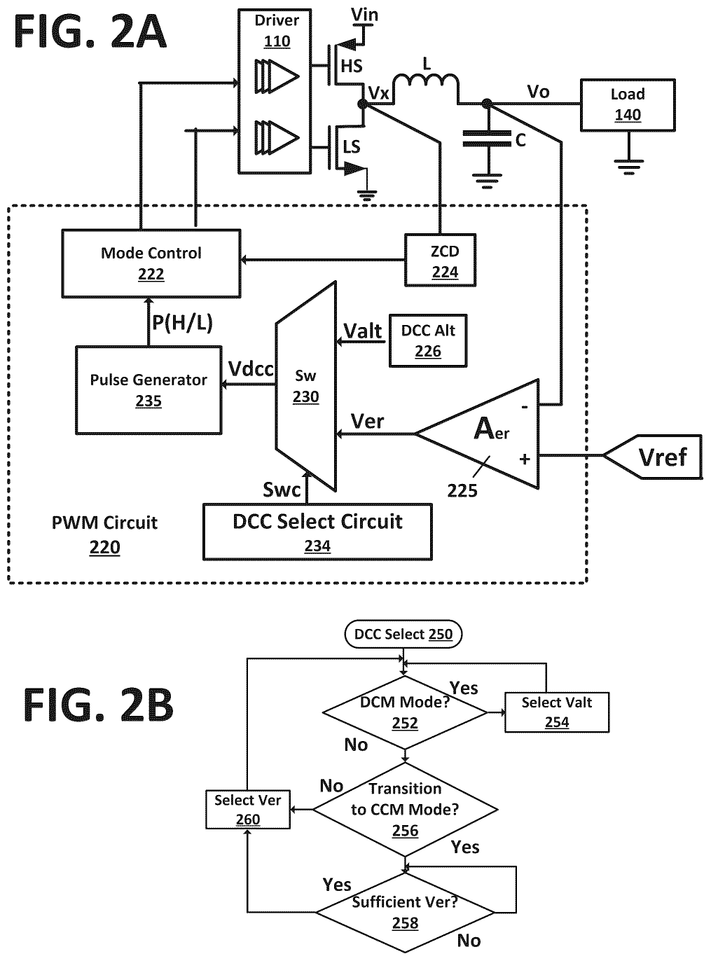

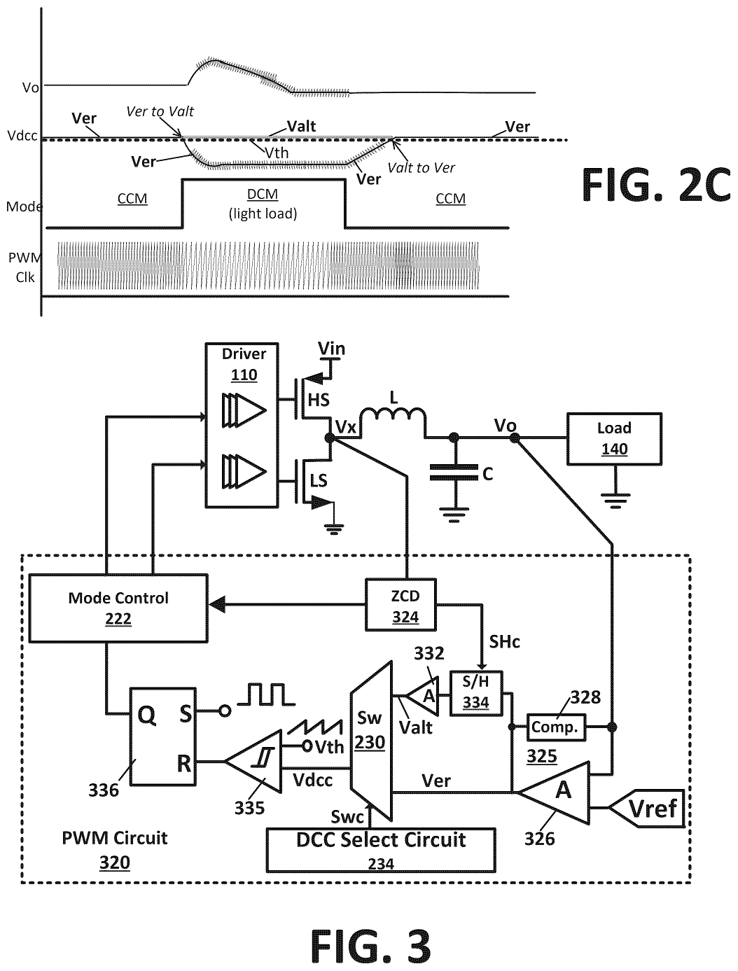

FIG. 2A is a schematic diagram of a buck type regulator with a pulse width modulation circuit in accordance with some embodiments. The regulator is similar to the regulator of FIG. 1, except, among other things, it has a pulse width modulation (PWM) circuit 220 with alternative duty cycle control for discontinuous mode. The PWM circuit 220 generally includes mode control circuit 222, zero crossing detector (ZCD) circuit 224, error amplifier 225, DCC alternate circuit 226, switch 230, DCC select circuit 234, and pulse generator circuit 235, coupled together as shown.

As with the circuit of FIG. 1, the PWM circuit 220 controls the ratio of on-time to off-time (duty cycle) of the HS switch to regulate the output voltage to a desired value (Vref). It also controls the high-side and low-side switches to operate in a suitable mode (CCM, DCM) based on inductor-current sensing circuitry that is part of the ZCD circuit 224. However, in contrast with the circuit of FIG. 1, PWM circuit 220 has circuitry to adjust how the pulse generator 235 operates, depending, among other things, on whether the regulator is in a CCM or DCM operational state. Here, the pulse generator 235 is represented as a general circuit block that generates a pulse signal to mode control circuit 222 to control a duty cycle for regulator on-time based on the duty cycle control signal (Vdcc). it may be implemented with any suitable circuit configuration including the pulse generator circuit of FIG. 1, with a comparator and latch, to provide the duty cycle controlled pulse signal to a driver circuit, e.g., through a mode control circuit as is the case in the depicted example. It should be appreciated that depending on implemented mode control and error amplifier configurations, any suitable circuit structure may be used for the pulse generator circuit 235.

In the depicted embodiment, the pulse generator 235 receives a duty cycle control signal (Vdcc) that is sourced from either the error amplifier 225 (Ver signal) or from the DCC alternative circuit 226 (Valt signal), as dictated by mux switch 230. (Hereafter, the switch 230 will be referred to as mux switch to avoid confusion with the high and low side inductor input power switches.) In this example, mux switch 230 functions as an analog multiplexer switch to couple either Ver or Valt through to the Vdcc signal node. It should be appreciated that any combination of switches, e.g., analog switches, transistors, transistor pass gate structures, etc. could be used to implement such a mux switch (or switch network) and will likely depend on the particular circuit techniques used for PWM circuit 220. For example, the PWM circuit may be implemented with analog, digital or both analog and digital circuits and thus, the particular approaches for circuit components such as switch 230 will depend on the specific design implementations for the PWM circuit 220 and its constituent blocks.

The error amplifier 225 may be similar to amplifier 125. It provides the error signal (Ver), a difference between the sensed output voltage (Vo) and the desired regulated voltage level (Vref) with a suitable frequency response. On the other hand, the DCC alternate circuit 226 generates a signal (Valt) that is an alternative to Ver for controlling the pulse generator 235 duty cycle. The Valt signal may be generated in any suitable manner, some examples of which are presented below. It serves, essentially, to place the pulse generator 235 in a more ready state for DCM to CCM transitions, especially when large load increases occur. In some embodiments, it maintains the Vdcc at a higher level during a DCM mode than it otherwise would be at if sourced from the real-time error signal (Ver). This is represented in FIG. 2C, which shows the duty cycle control signal (Vdcc) in CCM and DCM operational states. It can be seen that when the regulator transitions from CCM to DCM, the Vdcc is switched from the Ver signal to the Valt signal, which is higher than Ver during this depicted discontinuous mode.

The mux switch 230 selects either the Ver or Valt signal based on a switch control signal (Swc) from the DCC select circuit 234. FIG. 2B is a flow diagram showing a routine for implementing a DCC select circuit 234 in accordance with some embodiments. At 252, the circuit determines if the regulator is in DCM mode. If so, then it causes the mux switch 230 to select the DCC alternate (Valt) signal, decoupling duty cycle control from the feedback error amplifier. From here, it loops back to 252, essentially checking/confirming the regulator is in DCM.

When the regulator leaves DCM, the routine proceeds to 256 and determines if the regulator is transitioning from DCM to CCM. If so, then it moves to 258 and determines when/if the feedback error signal (Ver) is sufficient to take over as the control (Vdcc) for pulse generator 235. For example, it may compare it against the Valt level. This is depicted in FIG. 2C which shows a Valt-to-Ver transition point where Ver is greater than Valt. The circuit essentially loops upon itself at 258 until the Ver level is large enough. Once it becomes sufficient, the circuit proceeds to 260 and causes the mux switch 234 to switch control back to the feedback error signal (Ver). Note that at 256, if it was determined that the regulator had not just transitioned from DCM to CCM (implying already in CCM), then it goes directly to 260 and maintains selection of the Ver signal as the Vdcc control signal.

The transition determination at 256 may practically be achieved in any suitable manner. For example, when the regulator transitions from a DCM to CCM state, and the Ver level is determined to be sufficient, a flag may be set to indicate that the transition has occurred and the regulator is in a more steady CCM state. This determination at 256 can serve to avoid Vdcc chatter issues once the regulator has already transitioned into CCM. The flag may then be reset when the regulator enters DCM mode. It should be appreciated that the DCC select circuit 234 may be implemented in any suitable manner, for example, with discrete analog and/or digital circuit elements, or with firmware or synthesized logic, as part of a special purpose logic block or as part of a more general control block. For example, in some embodiments, there may be a digital control block comprising logic such as one or more finite state machines, discrete circuit components and/or controller(s) to perform such functions as DCM/CCM exit/entry, generation of the DCC alternative signal, mode control implementation, zero cross detection, and the like. The depicted blocks, e.g., mode control circuit 222, ZCD circuit 224, DCC alternate circuit 226, may be distinct or may be part of such a digital block, which may be used, itself, for a single or for multiple regulator circuits.

FIG. 3 is a schematic diagram showing a regulator with duty cycle control circuitry in accordance with additional different embodiments. In this example, a pulse generator circuit is implemented with comparator and latch circuits 335, 336, respectively. A mux switch 230 provides the comparator with a duty cycle control signal (Vdcc) sourced from either feedback error amplifier 325 (Ver signal) or from a DCC alternate circuit (Valt signal) that is formed from an amplifier 332 and a sample and hold (S/H) circuit 334, coupled as shown.

The S/H circuit tracks the Ver signal and stores its value when triggered by a control signal (SHc) from a ZCD circuit 324. This sampled Ver value is buffered through amplifier 332 and provided as the duty cycle control signal (Vdcc) when selected by mux switch 230. A DCC select circuit 234, as discussed above, controls mux switch 230 to select either the Valt or Ver signal. In this way, when the regulator enters the DCM mode, the S/H circuit 334 records the feedback error output voltage (Ver), when last in CCM mode, upon entry into DCM mode. During the DCM operation mode regulation period, the Vdcc value is fixed at this “held” CCM level. In some embodiments, when there is a transition from DCM to CCM, the fixed duty cycle control (DCC) operation continues until the Ver becomes sufficient, e.g., is measured to reach the Valt level or a programmed amount of time has elapsed. For example, instead of comparing the Ver and Valt levels, the DCC select circuit 234 might release control back to the Ver signal after a programmed number of PWM cycles has been counted.

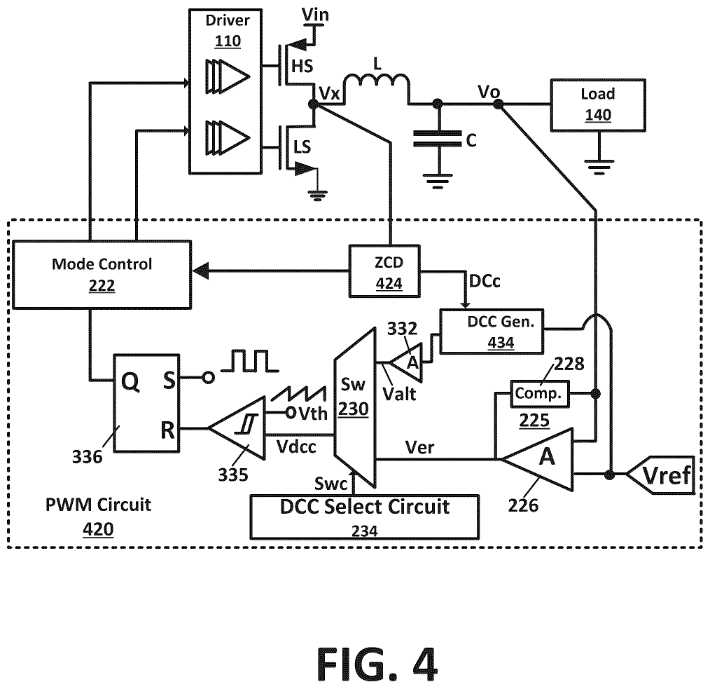

FIG. 4 is a schematic diagram showing a regulator with duty cycle control circuitry in accordance with additional different embodiments. This circuit is similar to the circuit of FIG. 3 except the DCC alternative circuit is implemented with a duty cycle generation circuit 434 rather than a sample and hold circuit. The duty cycle generation circuit determines (e.g., identifies, calculates, approximates) an alternate duty cycle control value (Vdcc) based on the input voltage (Vin) and output voltage (Vo) when the circuit enters the DCM mode. This determined alternate duty cycle control value can then set a cross point with the ramp generator at comparator 335, which can then be fixed for DCM operation. When there is a transition from DCM to CCM, this fixed alternative duty cycle control operation can be maintained as discussed above until it is determined or assumed that the feedback error signal (Ver) is sufficient to take back duty cycle control.

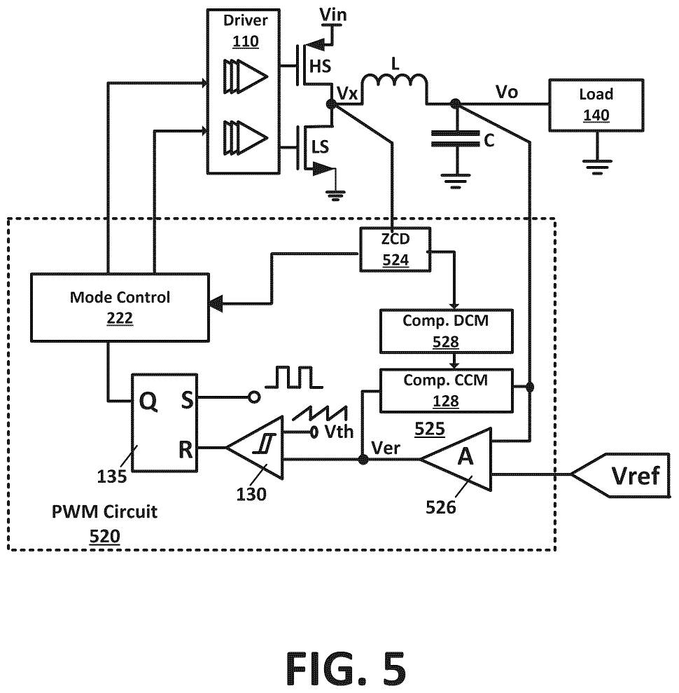

FIG. 5 is a schematic diagram showing a regulator with duty cycle control circuitry in accordance with additional different embodiments. With this example, instead of using an alternate duty cycle control scheme, duty cycle control is maintained from the feedback error signal Ver but with a feedback error amplifier 525 that has at least two different compensation response options. In the depicted example, the feedback error amplifier 525 includes separate compensation circuits 128 and 528 for providing different CCM and DCM frequency response characteristics, respectively. The DCM compensation circuit 528 is engaged (e.g., by the ZCD circuit 524) during DCM operation, or at least during a DCM-to-CCM transition. This implementation changes the DCM operation bandwidth of the regulator's voltage regulation loop.

The AC response (as tuned through compensation circuit 128) is normally optimized for CCM operation since that is where it operates most of the time. Thus, it can function as a second-order system with two poles at (or near) the regulator's LC corner frequency. However, with a fixed CCM-tuned compensation, the error amplifier, as addressed above, behaves differently in a DCM mode. In a DCM mode, with the low side switch being disabled, the two poles split, and the system becomes heavily damped, which can lead to a substantial reduction in bandwidth, resulting in a slowly reacting error signal (Ver) for DCM operation. However, with the use of the alternative compensation circuit (528), the system can be tuned for DCM, as well as for CCM, operation, giving it increased response with the ability to better adjust and compensate for large increased load events even when in a DCM mode.

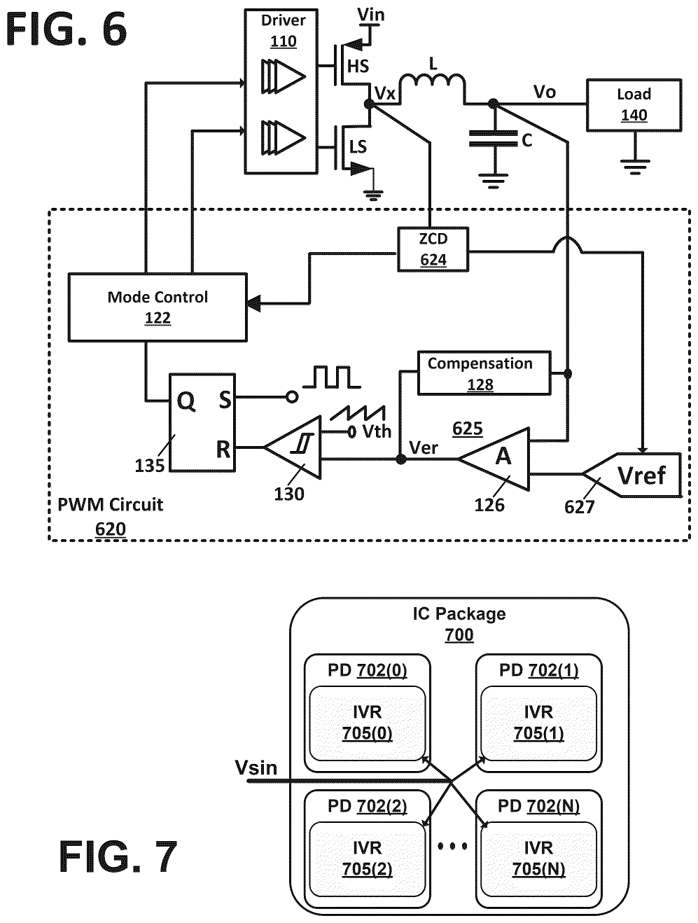

FIG. 6 is a schematic diagram showing a regulator with duty cycle control circuitry in accordance with additional different embodiments. With this example, a PWM circuit 620 is similar to the circuit of FIG. 1, except that it has a dynamically adjustable Vref circuit 627 that may be changed by a ZCD circuit 624 in response to CCM/DCM mode changes. When the ZCD circuit 624 determines that the regulator is to transition from DCM to CCM mode, it changes the Vref circuit 627, e.g., a digital-to-analog converter(DAC) used to create the Vref signal, to cause the error amplifier to generate a Ver level that will more quickly increase the on-time duty cycle from PWM circuit 620. This may be effectuated through a strobe, or pulse, so that the Vref level is bumped for a limited burst before changing back to the steady-state regulated voltage level.

FIG. 7 is a schematic diagram showing an integrated circuit (IC) package 700 in accordance with some embodiments. This is a simplified view illustrating how multiple IVRs (integrated voltage regulators) such as any of the disclosed buck regulator circuits disclosed herein may be used in an IC package to provide power to different power domains 702 within the package. The regulators receive an input supply (Vsin), which may or may not be from off the package. Each IVR provides a regulated supply voltage to its associated power domain from this common input supply.

The IC package may include a plurality of different chips (or dies) including compute dies, graphics processing dies, artificial intelligence (AI) processing dies, memory dies, input/output (IO) dies, and/or any combination of the same. The dies may be mounted in 2.5D and/or 3D stacks with one or more base substrates, interposers and/or bridges to couple at least some of the dies to one another. In some embodiments, the regulators have capacitors and inductors that may be disposed in the dies, within the package outside of the dies or even outside of the package. That is, integrated voltage regulators, as used herein, refers to regulator circuitry such as control circuits and inductor high side and low side switches being formed on circuits in at least some of the dies they serve but not all of the regulator components need be part of the chips, or dies, themselves.

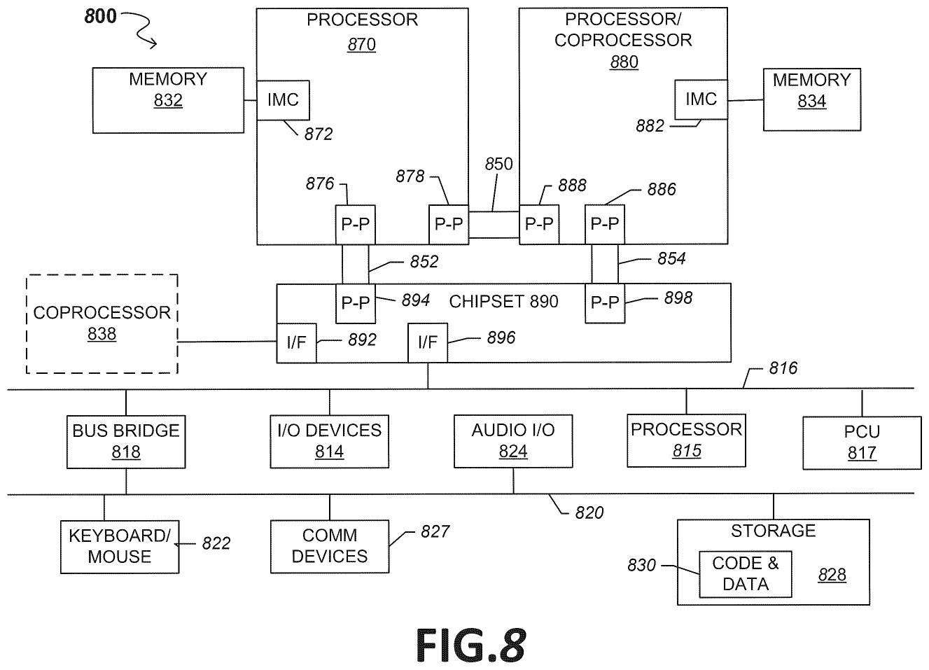

FIG. 8 illustrates an example computing system. Multiprocessor system 800 is an interfaced system and includes a plurality of processors including a first processor 870 and a second processor 880 coupled via an interface 850 such as a point-to-point (P-P) interconnect, a fabric, and/or bus. In some examples, the first processor 870 and the second processor 880 are homogeneous. In some examples, the first processor 870 and the second processor 880 are heterogenous. Though the example system 800 is shown to have two processors, the system may have three or more processors, or may be a single processor system. In some examples, the computing system is implemented, wholly or partially, with a system on a chip (SoC) or a multi-chip (or multi-chiplet) module, in the same or in different package combinations.

Processors 870 and 880 are shown including integrated memory controller (IMC) circuitry 872 and 882, respectively. Processor 870 also includes interface circuits 876 and 878, along with core sets. Similarly, second processor 880 includes interface circuits 886 and 888, along with a core set as well. A core set generally refers to one or more compute cores that may or may not be grouped into different clusters, hierarchal groups, or groups of common core types. Cores may be configured differently for performing different functions and/or instructions at different performance and/or power levels. The processors may also include other blocks such as memory and other processing unit engines.

Processors 870, 880 may exchange information via the interface 850 using interface circuits 878, 888. IMCs 872 and 882 couple the processors 870, 880 to respective memories, namely a memory 832 and a memory 834, which may be portions of main memory locally attached to the respective processors.

Processors 870, 880 may each exchange information with a network interface (NW I/F) 890 via individual interfaces 852, 854 using interface circuits 876, 894, 886, 898. The network interface 890 (e.g., one or more of an interconnect, bus, and/or fabric, and in some examples is a chipset) may optionally exchange information with a coprocessor 838 via an interface circuit 892. In some examples, the coprocessor 838 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 870, 880 or outside of both processors, yet connected with the processors via an interface such as P-P interconnect, such that either or both processors'local cache information may be stored in the shared cache if a processor is placed into a low power mode.

Network interface 890 may be coupled to a first interface 816 via interface circuit 896. In some examples, first interface 816 may be an interface such as a Peripheral Component Interconnect (PCI) interconnect, a PCI Express interconnect, or another I/O interconnect. In some examples, first interface 816 is coupled to a power control unit (PCU) 817, which may include circuitry, software, and/or firmware to perform power management operations with regard to the processors 870, 880 and/or co-processor 838. PCU 817 provides control information to one or more voltage regulators configured in accordance with the buck regulator circuits discussed herein to cause the voltage regulator(s) to generate the appropriate regulated voltage(s). PCU 817 also provides control information to control the operating voltage generated. In various examples, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other examples, power management operations to be performed by PCU 817 may be implemented externally to a processor, such as by way of a separate power management integrated circuit (PMIC) or another component external to the processor. In yet other examples, power management operations to be performed by PCU 817 may be implemented within BIOS or other system software. Along these lines, power management may be performed in concert with other power control units implemented autonomously or semi-autonomously, e.g., as controllers or executing software in cores, clusters, IP blocks and/or in other parts of the overall system.

Various I/O devices 814 may be coupled to first interface 816, along with a bus bridge 818 which couples first interface 816 to a second interface 820. In some examples, one or more additional processor(s) 815, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 816. In some examples, second interface 820 may be a low pin count (LPC) interface. Various devices may be coupled to second interface 820 including, for example, a keyboard and/or mouse 822, communication devices 827 and storage circuitry 828. Storage circuitry 828 may be one or more non-transitory machine-readable storage media as described below, such as a disk drive or other mass storage device which may include instructions/code and data 830 and may implement the storage in some examples. Further, an audio I/O 824 may be coupled to second interface 820. Note that other architectures than the point-to-point architecture described above are possible. For example, instead of the point-to-point architecture, a system such as multiprocessor system 800 may implement a multi-drop interface or other such architecture.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

Illustrative examples of the technologies disclosed herein are provided below. An embodiment of the technologies may include any one or more, and any compatible combination of, the examples described below.
Example 1 is an apparatus that includes a pulse generator circuit and a multiplexer switch. The pulse generator circuit includes a duty cycle (DCC) control input node. The multiplexer switch includes a switch output coupled to the DCC input node, a first switch input coupled to an error amplifier output node, and a second switch input coupled to an output node of an alternate DCC circuit.
Example 2 includes the subject matter of example 1, and wherein the pulse generator circuit includes a comparator with a first input node coupled to the DCC control input node.
Example 3 includes the subject matter of any of examples 1 and 2, and wherein the comparator has a second input node coupled to a triangle wave generator.
Example 4 includes the subject matter of any of examples 1-3, and wherein the alternate DCC circuit includes a sample and hold circuit coupled to a zero cross detection circuit and to the error amplifier output node.
Example 5 includes the subject matter of any of examples 1-4, and wherein the alternate DCC circuit includes a DCC generation circuit to calculate a DCC value.
Example 6 includes the subject matter of any of examples 1-5, and wherein the error amplifier output node is part of an error amplifier circuit that includes a compensation circuit.
Example 7 includes the subject matter of any of examples 1-6, and wherein the pulse generator circuit includes an output node coupled to a drive circuit input node to control an on-time of a buck regulator high side switch.
Example 8 includes the subject matter of any of examples 1-7, and comprising a mode control circuit coupled between the pulse generator output node and the drive circuit input node.
Example 9 includes the subject matter of any of examples 1-8, and wherein the multiplexer switch includes a plurality of transistor switches to couple a selected one of the error amplifier output node and the alternative DCC generation circuit output node to the DCC input node.
Example 10 includes the subject matter of any of examples 1-9, and comprising a voltage regulator including the pulse generator circuit and the multiplexer switch.
Example 11 is an apparatus that includes a driver circuit and a pulse width modulation (PWM) circuit. The driver circuit includes (i) an output coupled to a power switch gate control node of a switching voltage regulator, and (ii) a driver circuit input node. The pulse width modulation circuit includes a PWM output node coupled to the driver circuit input node. The PWM circuit includes an error amplifier that is coupled to a zero crossing detection (ZCD) circuit to select the error amplifier to operate in one of at least two different modes based on whether the voltage regulator is to be in a continuous or discontinuous current mode.
Example 12 includes the subject matter of example 11, and wherein the ZCD circuit is coupled to the error amplifier circuit through a controllable reference voltage generator to change a generated reference voltage responsive to the regulator transitioning from the discontinuous current mode to the continuous current mode.
Example 13 includes the subject matter of any of examples 11-12, and wherein the error amplifier circuit has first and second compensation circuits, the ZCD circuit to select one of the first and second compensation circuits based on whether the voltage regulator is to be in the continuous or discontinuous current mode.
Example 14 includes the subject matter of any of examples 11-13, and wherein the second compensation circuit provides the error amplifier with a faster response than the first compensation circuit when it is in the discontinuous current mode.
Example 15 includes the subject matter of any of examples 11-14, and wherein the PWM circuit includes a pulse generator circuit including a comparator with a first input node coupled to a DCC control node that is coupled to an output of the error amplifier.
Example 16 includes the subject matter of any of examples 11-15, and wherein the comparator has a second input node coupled to a triangle wave generator.
Example 17 includes the subject matter of any of examples 11-16, and comprising a mode control circuit coupled between the pulse generator circuit and the driver circuit input node.
Example 18 is an apparatus that includes first and second dies. The first and second dies are in a multi-chip integrated circuit (IC) package. The second die is coupled with the first die. The first die includes at least one buck type switching voltage regulator. The at least one voltage regulator includes a pulse generator circuit and a multiplexer switch circuit. The pulse generator circuit includes a duty cycle (DCC) control input node. The multiplexer switch circuit includes (i) a switch output coupled to the DCC input node, (ii) a first switch input coupled to an error amplifier output node, and (iii) a second switch input coupled to an output node of an alternate DCC circuit.
Example 19 includes the subject matter of example 18, and wherein the pulse generator circuit includes a comparator with a first input node coupled to the DCC control input node.
Example 20 includes the subject matter of any of examples 18-19, and wherein the comparator has a second input node coupled to a triangle wave generator.
Example 21 includes the subject matter of any of examples 18-20, and wherein the alternate DCC circuit includes a sample and hold circuit coupled to a zero cross detection circuit and to the error amplifier output node.
Example 22 includes the subject matter of any of examples 18-21, and wherein the alternate DCC circuit includes a DCC generation circuit.
Example 23 includes the subject matter of any of examples 18-22, and wherein the error amplifier output node is part of an error amplifier circuit that includes a compensation circuit.
Example 24 includes the subject matter of any of examples 18-23, and wherein the pulse generator circuit includes an output node coupled to a drive circuit input node to control an on-time of a buck regulator high side switch.
Example 25 includes the subject matter of any of examples 18-24, and comprising a mode control circuit coupled between the pulse generator output node and the drive circuit input node.
Example 26 includes the subject matter of any of examples 18-25, and wherein the multiplexer switch includes a plurality of transistor switches to couple a selected one of the error amplifier output node and the alternative DCC generation circuit output node to the DCC input node.
Example 27 includes the subject matter of any of examples 18-26, and comprising a DCC select circuit coupled to the multiplexer switch.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “circuit” or “module” may refer to one or more passive and/or active components that are arranged to cooperate with one another to provide a desired function. It should be appreciated that different circuits or modules may consist of separate components, they may include both distinct and shared components, or they may consist of the same components. For example, A controller circuit may be a first circuit for performing a first function, and at the same time, it may be a second controller circuit for performing a second function, related or not related to the first function.

The meaning of “in” includes “in” and “on” unless expressly distinguished for a specific description.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

The terms “substantially,” “close,” “approximately,” “near,” and “about,” unless otherwise indicated, generally refer to being within +/−10% of a target value.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

It is pointed out that those elements of the figures having the same reference numbers (or names) as the elements of any other figure can operate or function in any manner similar to that described but are not limited to such.

For purposes of the embodiments, unless expressly described differently, the transistors in various circuits and logic blocks described herein may be implemented with any suitable transistor type such as field effect transistors (FETs) or bipolar type transistors. FET transistor types may include but are not limited to metal oxide semiconductor (MOS) type FETs such as tri-gate, FinFET, and gate all around (GAA) FET transistors, as well as tunneling FET (TFET) transistors, ferroelectric FET (FeFET) transistors, or other transistor device types such as carbon nanotubes or spintronic devices.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are dependent upon the platform within which the present disclosure is to be implemented.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context. As defined herein, the term “responsive to” means responding or reacting readily to an action or event. Thus, if a second action is performed “responsive to” a first action, there is a causal relationship between an occurrence of the first action and an occurrence of the second action. The term “responsive to”indicates the causal relationship.

As defined herein, the term “processor” means at least one hardware circuit configured to carry out instructions contained in program code. The hardware circuit may be implemented with one or more integrated circuits. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a graphics processing unit (GPU), a controller, a system on a chip (SoC), an application processor, an integrated circuit incorporating a combination of one or more of the aforesaid items, etc.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. For example, buck regulator examples have been described with regard to DCM/CCM transition management for single phase regulators, but it should be appreciated that the same concepts and PWM circuits may be used in multi-phase regulators as well. The description is thus to be regarded as illustrative instead of limiting.

What is claimed is:

1. An apparatus, comprising:
a pulse generator circuit including a duty cycle (DCC) control input node; and
a multiplexer switch including: (i) a switch output coupled to the DCC input node, (ii) a first switch input coupled to an error amplifier output node, and (iii) a second switch input coupled to an output node of a DCC alternate circuit.

2. The apparatus of claim 1, wherein the pulse generator circuit includes a comparator with a first input node coupled to the DCC control input node.

3. The apparatus of claim 2, wherein the comparator has a second input node coupled to a triangle wave generator.

4. The apparatus of claim 2, wherein the DCC alternate circuit includes a sample and hold circuit coupled to a zero cross detection circuit and to the error amplifier output node.

5. The apparatus of claim 2, wherein the DCC alternate circuit includes a DCC generation circuit to identify a DCC value based on an input voltage and a target reference voltage.

6. The apparatus of claim 1, wherein the error amplifier output node is part of an error amplifier circuit that includes a compensation circuit.

7. The apparatus of claim 1, wherein the pulse generator circuit includes an output node coupled to a drive circuit input node to control an on-time of a buck regulator high side switch.

8. The apparatus of claim 7, comprising a mode control circuit coupled between the pulse generator output node and the drive circuit input node.

9. The apparatus of claim 1, wherein the multiplexer switch includes a plurality of transistor switches to couple a selected one of the error amplifier output node and the DCC alternate circuit output node to the DCC input node.

10. The apparatus of claim 1, comprising a voltage regulator including the pulse generator circuit and the multiplexer switch.

11. An apparatus, comprising:
a driver circuit including (i) an output coupled to a power switch control node of a switching voltage regulator, and (ii) a driver circuit input node; and
a pulse width modulator (PWM) circuit including a PWM output node coupled to the driver circuit input node, the PWM circuit including an error amplifier that is coupled to a zero crossing detection (ZCD) circuit to select the error amplifier to operate in one of at least two different modes based on whether the voltage regulator is to be in a continuous or discontinuous current mode.

12. The apparatus of claim 11, wherein the ZCD circuit is coupled to the error amplifier circuit through a controllable reference voltage generator to change a generated reference voltage responsive to the regulator transitioning from the discontinuous current mode to the continuous current mode.

13. The apparatus of claim 11, wherein the error amplifier circuit has first and second compensation circuits, the ZCD circuit to select one of the first and second compensation circuits based on whether the voltage regulator is to be in the continuous or discontinuous current mode.

14. The apparatus of claim 13, wherein the second compensation circuit provides the error amplifier with a faster response than the first compensation circuit when it is in the discontinuous current mode.

15. The apparatus of claim 11, wherein the PWM circuit includes a pulse generator circuit including a comparator with a first input node coupled to a DCC control node that is coupled to an output of the error amplifier.

16. The apparatus of claim 15, wherein the comparator has a second input node coupled to a triangle wave generator.

17. The apparatus of claim 15, comprising a mode control circuit coupled between the pulse generator circuit and the driver circuit input node.

18. An apparatus, comprising:
a first die in a multi-chip integrated circuit (IC) package; and
a second die in the IC package, the second die being coupled with the first die, the first die including at least one buck type switching voltage regulator that includes:
a pulse generator circuit including a duty cycle (DCC) control input node; and
a multiplexer switch including: (i) a switch output coupled to the DCC input node, (ii) a first switch input coupled to an error amplifier output node, and (iii) a second switch input coupled to an output node of a DCC alternate circuit.

19. The apparatus of claim 18, wherein the pulse generator circuit includes a comparator with a first input node coupled to the DCC control input node.

20. The apparatus of claim 19, wherein the comparator has a second input node coupled to a triangle wave generator.
